(19) United States
(12) Patent Application Publication
(10) Pub. No.: US 2025/0058423 A1
(43) Pub. Date: Feb. 20, 2025

(54) File for creating a non-planar contour, in particular with a transverse curvature

(71) Applicant: Lothar ERTL, Fürth (DE)

(72) Inventor: Lothar ERTL, Fürth (DE)

(21) Appl. No.: 18/720,809

(22) PCT Filed: Dec. 22, 2022
(86) PCT No.: PCT/EP2022/087527

§ 371 Date: Jun. 17, 2024

(30) Foreign Application Priority Data
Dec. 23, 2021 (DE) 10 2021 215 021.7

(51) Int. Cl. B24B 19/02

(52) U.S. Cl. CPC B24B 19/02

(57) ABSTRACT

A file for creating a non-planar contour, in particular with a transverse curvature on a workpiece, including a longitudinal axis, at least one file element with an abrasive machining surface and a depth-stop element with a non-abrasive sliding surface, wherein the at least one file element and the depth-stop element are arranged next to one another in a plane orientated perpendicular to the longitudinal axis.

### CROSS-REFERENCES TO RELATED APPLICATIONS

This application claims the priority, under 35 U.S.C. § 119, of German Patent Application, Serial No. DE 10 2021 215 021.7, filed Dec. 23, 2021, the content of which is incorporated herein by reference in its entirety as if fully set forth herein.

### FIELD OF THE INVENTION

The invention relates to a file for creating a non-planar contour, in particular with a transverse curvature on a workpiece.

### BACKGROUND OF THE INVENTION

In the manufacture of a stringed instrument, in particular a plucked string instrument with a fingerboard, so-called fret bars are attached to the fingerboard at certain evenly decreasing distances towards the bridge, depending on the scale length, in order to determine certain pitches by pressing strings when playing a plucked string instrument. The scale length is the length of a free-swinging string between a nut at the upper end of the fingerboard and a bridge inlay in the bridge on the soundboard of the instrument. The distance from the nut to the first fret is calculated by dividing the length of the scale length by the divisor of 17.817. This distance is subtracted from the scale length and the result divided by the same divisor of 17.817. This gives the distance from the first fret to the second fret. The other distances can be calculated accordingly.

The fret bars are configured to be rod-shaped, fixed in the fingerboard, i.e. sunk into the fingerboard at certain points except for their transversely curved regions, and then dressed so that the fret bars do not protrude differently along the fingerboard. As a result of the dressing, the originally round outer contours of the fret bars are affected. The subsequent restoration of the round outer contours while retaining the fret bar levels created by the dressing process is time-consuming and complicated, but absolutely necessary in order to avoid unwanted buzzing noises on the one hand and to retain the cross-sectional centers of the fret bars, which run perpendicular to the fingerboard, and the pitches defined by them on the other hand. Any undercutting of the fret bar height levels created by the dressing process must be avoided.

### SUMMARY OF THE INVENTION

It is an object of the invention to simplify the creation of a non-planar contour, in particular with a transverse curvature, on a workpiece, in particular a fret-bar type workpiece, while maintaining a height level already created on the workpiece.

This object is achieved by a file for creating a non-planar contour, in particular with a transverse curvature, on a workpiece, wherein the file comprises a longitudinal axis, at least one file element with an abrasive machining surface, a depth stop element with a non-abrasive sliding surface, wherein the at least one file element and the depth stop element are arranged next to one another in a plane orientated perpendicular to the longitudinal axis.

The essence of the invention is that the file has at least one file element with an abrasive machining surface and a depth stop element with a non-abrasive sliding surface.

Due to the fact that the non-abrasive sliding surface is provided on the file according to the invention it is ensured that unwanted material removal in this region is prevented during machining of the workpiece. The non-abrasive region of the file serves as a depth stop.

This prevents the fret bar height created by a dressing process from being unintentionally reduced on a fret bar anchored in a fingerboard. Due to the at least one abrasive file element, however, it is possible to machine the remaining contour of the fret bar. A fret bar of this type forms a workpiece that can be machined with the file. In particular, the fret bar originally has a rounded outer contour, which is impaired, in particular flattened, as a result of dressing. The file according to the invention makes it possible to produce a non-planar contour, in particular with a rounding and/or a transverse curvature. In particular, the contour of the workpiece that can be produced can be variably determined in dependence on the contour of the machining surface. In a plane perpendicular to the longitudinal axis of the workpiece, the contour is in particular a spline of the nth degree, in particular a spline of the 4th degree.

The workpiece to be machined can originally also have a polygonal outer contour, in particular a triangular cross-section.

The file can also comprise multiple, in particular at least two and in particular exactly two, file elements. The file can also comprise multiple depth stop elements. Multiple file elements and/or multiple depth-stop elements can be combined with one another to form the file with depth-stop function.

The at least one file element and the at least one depth stop element are, in particular, detachably connected to one another. This makes it easier to replace the at least one file element and/or the at least one depth stop element. Alternatively, it is possible for the at least one file element and the at least one depth stop element to be non-detachably connected to one another. Non-detachable means that the elements can only be separated destructively. The file is configured to be particularly robust when the elements are non-detachably connected.

The at least one file element is made in particular from a tool material, in particular from steel and in particular from a tool steel. Other tool materials are also possible, in particular aluminum materials. The abrasive machining surface is provided in particular with a diamond coating and/or sapphire coating. However, the abrasive machining surface can also be designed with other types of coating and additionally or alternatively have a surface structure, in particular with regularly or irregularly arranged elevations and depressions. In particular, the abrasive machining surface is hewn and, in particular, hand-hewn.

The at least one depth stop element is made in particular from a high-strength material, in particular from a high-strength, machinable high-performance and/or engineering plastic material, such as in particular polyether ether ketone (PEEK), polyphenylene sulphide (PPS) or polyimide (PI).

The non-abrasive sliding surface is designed in such a manner that it is in particular free of abrasive coatings and is formed in particular by a base material of the depth stop element. The base material of the depth stop element can be a layered material such as TiAlN. The non-abrasive machining surface is configured to be smooth. The sliding surface can be ground and/or polished. The sliding surface has an arithmetic center roughness value Ra of at most 0.4 μm, in particular of at most 0.2 μm, in particular of at most 0.1 μm, in particular of at most 0.05 μm and in particular of at most 0.025 μm.

In particular, the two external file elements are designed identically and are arranged mirror-symmetrically to each other with respect to a center plane that has the longitudinal axis of the file base body. This simplifies the production of the file, as only two different file elements need to be provided in order to produce the file base body.

Due to the fact that the at least one file element and the depth stop element are arranged next to each other in a plane orientated perpendicularly to the longitudinal axis simplifies the machining of the fret bars. The file can be placed directly on the fret bar with the at least one file element and the fret bar can thus be machined. The depth-stop element prevents unintentional machining of the fret bar in the depth direction, in that the depth-stop element rests either directly on the fret bar to be machined or on a laterally adjacent fret bar. In particular, the at least one file element and the depth stop element are orientated essentially parallel to each other along the longitudinal axis and in particular parallel to each other along the longitudinal axis. The at least one file element and the depth stop element are arranged at a distance from one another, in particular at a distance orientated perpendicular to the longitudinal axis, in the plane orientated perpendicular to the longitudinal axis.

A file in which the at least one file element and the depth stop element are connected to each other, in particular in pairs, ensures a stable construction of the file base body. The manufacture and production of the file is simplified. The at least one file element and the depth stop element can be produced independently of one another and, in particular, the machining surface can be designed. After its production, the at least one file element is connected to another file element and/or to the depth stop element, in particular firmly connected to one another. The connection can be detachable, in particular by screws or clamps. The connection can also be configured to be non-detachable, for example by gluing, soldering or welding. Gluing is carried out in particular by means of a two-component construction adhesive based on epoxy resin.

In particular, the connection between the file elements can be improved, in particular additionally, by positive locking, for example by sliding the file elements onto one another along the longitudinal axis of the file according to a tongue and groove principle or at an angle of inclination relative to the longitudinal axis.

A file in which the abrasive machining surface is designed to be concave and in particular has a curvature with a radius of curvature which is in particular greater than an original radius of curvature of the workpiece simplifies the production of the transverse curvature on the workpiece. In particular, the abrasive machining surface is substantially concave throughout and in particular has a curvature throughout, in particular a constant curvature. This enables symmetrical self-adjustment of the file during filing movements to restore the transverse curvature and, in particular, a rounding. The plumb line through the local maximum of the original rounding onto the fingerboard and the plumb line through the center of the flattened workpiece onto the fingerboard tend to be congruent. It is advantageous if the radius of curvature of the abrasive machining surface is larger than the original radius of curvature of the workpiece.

In particular, the curvature of the abrasive machining surface is designed as a segment of a circle and has an opening angle relative to the center point of at least 30°, in particular at least 35°, in particular at least 40°, in particular at least 45°, in particular at least 50° and in particular at least 60° and in particular at most 85°.

It is additionally or alternatively possible for the concave, abrasive machining surface to be designed without continuous curvature. It has proven to be advantageous if at least one of the following criteria is met for the concave contour and, in particular, all of the following criteria are met. A first criterion relates to a lateral distance between the two axially extending edge regions of the machining surface. This distance must be greater than the width of the fret bar. A second criterion relates to the symmetry of the concave contour. The contour has the properties of an even real function. This means that the concave contour is configured to be mirror-symmetrical with respect to a plane of symmetry, wherein the plane of symmetry is orientated perpendicular to the width of the fret bar and includes the longitudinal axis of the file. It is possible to manufacture the fret bar with improved fret intonation. In a central region of the concave contour, the latter can be configured to be comparatively pointed. A third criterion relates to the arrangement of the local maximum of the fret bar. After complete rounding of the fret bar, its local maximum must be located closer to the axially extending edge regions of the file elements than to the surface of the fret bar. This means that the distance in the depth direction from the maximum of the fret bar to the underside of the file element is smaller than the distance in the depth direction from the local maximum of the fret bar to the surface of the fingerboard.

In particular, the machining surface is concave at least in sections. For example, the contour can also be convex in sections, in particular in the form of a bell curve. A bell curve has multiple, in particular two, turning points. It is advantageous if the concave curve is laterally limited by parallel edge regions without sharp-edged, i.e. discontinuous, steps.

Additionally or alternatively, the machining surface can also be designed to be convex in such a manner that a V-shaped recess is substantially provided, wherein the recess is rounded at the bottom. The production of such a recess is uncomplicated.

A file in which the at least one file element is profiled along the longitudinal axis is designed to be robust and can be produced in an advantageous, namely simplified, manner.

A file in which the contour of the machining surface and/or the sliding surface is constant along the longitudinal axis is advantageous in handling, has a robust design and enables uncomplicated production of the file base body.

A file in which the depth-stop element forms a file base body on which at least one recess for inserting the at least one file element is arranged enables an advantageous repair of individual fret bars, which can be rounded to maintain their level without all, in particular adjacent fret bars, also having to be dressed beforehand. It has been recognized that it is advantageous if the sliding surface of the depth stop element can be arranged outside the fret bar to be machined and in particular in the region of adjacent fret bars. This simplifies the design and construction of the file. The production effort is reduced. The depth stop element forms a file base body with at least one recess into which the at least one file element is inserted. In particular, the at least one file element is embedded on an underside of the file base body. The at least one file element is designed as a hollow file.

The file base body is in particular manufactured precisely, in particular finely milled, in particular ground, in particular polished with a flat, slidable underside, which forms the sliding surface. The sliding surface is also called the sliding face. In a plane defined by the local cross-sectional maxima of the individual fret bars, the file base body extends along a file base body length which is in particular greater than the sum of the two distances between two adjacent fret bars on the fingerboard. In particular, the file base body is dimensioned in such a manner that it initially rests on at least one or more frets arranged adjacent to the fret bar being machined at the beginning of machining. At the beginning of machining, the sliding surface, in particular in the case of a non-spring-mounted file element, will initially rest exclusively on the fret bar that can still just be reached with the sliding surface. Due to the fact that the sliding surface rests on at least two adjacent fret bars during the machining of the fret bar and in particular towards the end of the machining and is moved in a sliding manner in the working direction, unwanted material removal is reliably prevented.

In particular, it is conceivable that two file elements are arranged on the file base body. In particular, the file elements can have a substantially identical geometry but different grit sizes. A file of this type simplifies the machining of the workpiece, for example by first pre-machining with the file element of coarser grit and then finishing with the file element of finer grit. It is also conceivable to provide two file elements with identical grit sizes so that the file can continue to be used even if one of the two file elements is worn, damaged and/or destroyed.

A file comprising a holding element for holding the at least one file element, in particular in the at least one recess, ensures reliable fastening of the file element to the file base body. A holding element enables the file element to be held by positive locking and/or by frictional locking. In particular, the holding element is designed as a screw, in particular as a clamping screw, in particular in the form of a ball-head screw, as a through bolt or as a translation screw, in particular with a translation thread.

A file in which the at least one file element has an adjustment groove, in particular for holding engagement of the holding element, wherein the adjustment groove extends in particular along the depth direction of the file, enables reliable retention of the at least one file element. It is advantageous if the at least one file element has multiple, in particular exactly two, holding grooves. This results in particular in advantages with regard to the fine adjustment of the file elements on the file base body.

A file in which the adjustment groove has a variable groove depth in the depth direction of the file prevents unintentional loss of the at least one file element and in particular ensures reliable clamping of the at least one file element by means of the holding element.

A file in which the adjustment groove has a V-shaped groove profile in a plane perpendicular to the depth direction enables axial fixing of the file element by means of the holding element.

A file in which the at least one file element is arranged on the file base body in such a manner that a minimum turning point of the machining surface lies in a plane defined by the sliding surface or is set back from the plane by a vertical distance in the depth direction, wherein the distance is in particular less than 1.0 mm, in particular less than 0.7 mm, in particular less than 0.5 mm, in particular less than 0.3 mm, in particular less than 0.1 mm, and in particular greater than or equal to 0.001 mm, enables advantageous workpiece machining. An arrangement of the at least one file element relative to the file base body in such a manner that a minimum turning point of the machining surface is set back in the depth direction relative to a plane defined by the sliding surface advantageously ensures that a material protrusion remains on the fret bar to be machined after machining. The set-back arrangement is therefore particularly suitable for a file in which the at least one file element has a comparatively large roughness depth, i.e. is used for pre- or rough machining. Accordingly, an arrangement of the minimum turning point in the plane of the sliding surface is advantageous for a file with a fine or small roughness depth, which is to be used in particular for post-machining, in particular for finishing or fine machining. As a result, the fret bar can be machined with the post-machining file along its entire length so that its local cross-sectional maximum is located in the plane defined by the sliding surface.

A file in which the at least one file element is arranged to be mechanically preloaded in the depth direction, in particular by means of a compression spring, on the file base body enables an uncomplicated automated compensation of manufacturing tolerances, which can occur in particular with the file element, in particular if the file element is provided with a diamond coating.

A file in which the at least one file element is arranged on the file base body so as to be adjustable in the depth direction, in particular by means of a translation thread, in particular by means of a translation fine thread, enables the targeted positioning of the at least one file element relative to the file base body by fine adjustment.

The manufacture of a file element in which the at least one file element is designed in multiple pieces and in particular comprises a file holding element and a file insert element held by the file holding element is particularly cost-efficient. It has been found that the various functions that the file element fulfils can be separated from one another. The holding function of the file element is fulfilled in particular by a file holding element. The file holding element can be advantageously held on the file base body and attached thereto. In particular, the file holding element is designed with corresponding design features for holding and/or fastening to the file base body. In particular, it has been found that it is not necessary for the file holding element to be made of a material with an abrasive surface, such as a diamond coating. The file holding element can be made from a comparatively cost-efficient material and/or from a material that is comparatively easy to machine mechanically.

In particular, a file insert element is held on and/or in the file holding element and/or attached thereto. The file insert element has the abrasive surface that is used to machine the workpiece. Since the file insert element is held by the file holding element, special design features on the file insert element are dispensable. The file insert element can be designed with a comparatively uncomplicated geometry and can therefore be produced cost-effectively. A special material, in particular with a diamond coating, can be used for the file insert element.

A file in which the at least one file element forms a file base body to which the depth stop element is fastened, in particular inserted into a recess, wherein in particular the non-abrasive sliding surface is designed to be convex at least in sections and in particular has a, in particular local, extremum, in particular a maximum, wherein in particular the extremum has a depth distance, which is orientated perpendicularly to a virtual connection line which is defined by contour end points of the abrasive machining surface that are facing one another, and/or wherein in particular the contour of the non-abrasive sliding surface has a width orientated perpendicularly to the longitudinal axis which is at most 0.3 mm, in particular at most 0.2 mm, in particular at most 0.15 mm and in particular between 0.01 mm and 0.1 mm, enables a reliable depth stop function. Due to the fact that the contour of the non-abrasive machining surface is configured to be convex at least in sections, a projection is formed on the central file element, which protrudes in particular with respect to the abrasive machining surfaces. The contour of the machining surface in the non-abrasive region therefore has a local extremum, in particular a local maximum.

In particular, the external file elements are arranged on the file base body in such a manner that the two curvatures have a common center of curvature, i.e. form a common curvature, which is in particular only interrupted by the depth stop element.

A file in which the extremum has a depth distance that is orientated perpendicular to a virtual connection line that is defined by contour end points of the abrasive machining surfaces facing each other ensures that unintentional material removal is prevented more reliably. The depth distance is in particular at least 0.02 mm, in particular at least 0.04 mm and in particular at least 0.05 mm. In particular, the depth distance in relation to a width oriented perpendicular to the longitudinal axis and in particular perpendicular to the center plane of the file base body is between half and five times the width.

A file in which the contour of the non-abrasive sliding surface has a width of at most 0.3 mm orientated perpendicular to the longitudinal axis ensures that undesirable material removal is avoided when the file is inclined in relation to the workpiece. The width is in particular between 0.01 mm and 0.1 mm.

Both the features set forth above and the features specified in the following description of embodiments of files according to the invention are each suitable, either on their own or in combination with one another, for further embodying the subject-matter according to the invention. The respective combinations of features do not represent any restriction with regard to the further development of the subject-matter of the invention, but are essentially merely exemplary in character.

Additional features, advantageous embodiments and details of the invention are shown in the following description of exemplary embodiments with reference to the drawing.

### BRIEF DESCRIPTION OF THE DRAWING

FIG. 1 shows a cross-section through a file according to the invention in a plane perpendicular to a longitudinal axis of a file base body,

FIG. 2 shows an enlarged detailed view of detail II in FIG. 1,

FIG. 3 shows a plan view of a file according to a second exemplary embodiment, in which the file base body forms a depth stop element,

FIG. 4 shows a sectional representation according to section line IV-IV in FIG. 3,

FIG. 5 shows a side view of the file in FIGS. 3 and 4,

FIG. 6 shows a side view of a file element of the file in FIG. 3,

FIG. 7 shows a sectional representation according to section line VII-VII in FIG. 6,

FIG. 8 shows a view from below of a file according to a third exemplary embodiment,

FIG. 9 shows a sectional view according to section line IX-IX in FIG. 8,

FIG. 10 shows a side view of a file according to a fourth exemplary embodiment with through bolt,

FIG. 11 shows a side view of a file element of the file in FIG. 10 with dismantled screw and file element,

FIG. 12 shows an enlarged sectional view of a file according to a fifth exemplary embodiment with a screw with a translation thread,

FIG. 13 shows a view of a multi-part file element corresponding to FIG. 6 according to a further embodiment,

FIG. 14 shows a side view of the file element according to FIG. 13,

FIG. 15 shows a sectional view according to section line XV-XV in FIG. 13,

FIG. 16 shows a view of a file element corresponding to FIG. 13 according to a further embodiment,

FIG. 17 shows a sectional view according to section line XVII-XVII in FIG. 16,

FIG. 18 shows a perspective view of a file according to a further exemplary embodiment,

FIG. 19 shows a sectional representation according to section line XIX-XIX in FIG. 18,

FIG. 20 shows a plan view of a file holding element receptacle of the file in FIG. 18,

FIG. 21 shows a sectional representation according to section line XXI-XXI in FIG. 20,

FIG. 22 shows a plan view of a file holding element guide of the file in FIG. 18,

FIG. 23 shows an enlarged sectional representation of a holding element of the file in FIG. 18,

FIG. 24 shows a plan view of a file holding element of a file according to a further exemplary embodiment,

FIG. 25 shows a sectional representation according to section line XXV-XXV in FIG. 24,

FIG. 26 shows a cross-sectional representation of a file insert element of the file in FIG. 24,

FIG. 27 shows a plan view of a file base body of a file with variable length according to a further exemplary embodiment,

FIG. 28 shows a sectional view according to section line XXVIII-XXVIII in FIG. 27,

FIG. 29 shows a sectional representation corresponding to FIG. 27 with a surface-adjustable file base body,

FIG. 30 shows a sectional representation of a file base body corresponding to FIG. 27 according to a further exemplary embodiment with a variably adjustable compression spring preload,

FIG. 31 shows a plan view of a file with several file elements according to a further exemplary embodiment,

FIG. 32 shows a sectional representation according to section line XXXII-XXXII in FIG. 31,

FIG. 33 shows a sectional representation according to section line XXXIII-XXXIII in FIG. 31.

### DESCRIPTION OF THE PREFERRED EMBODIMENTS

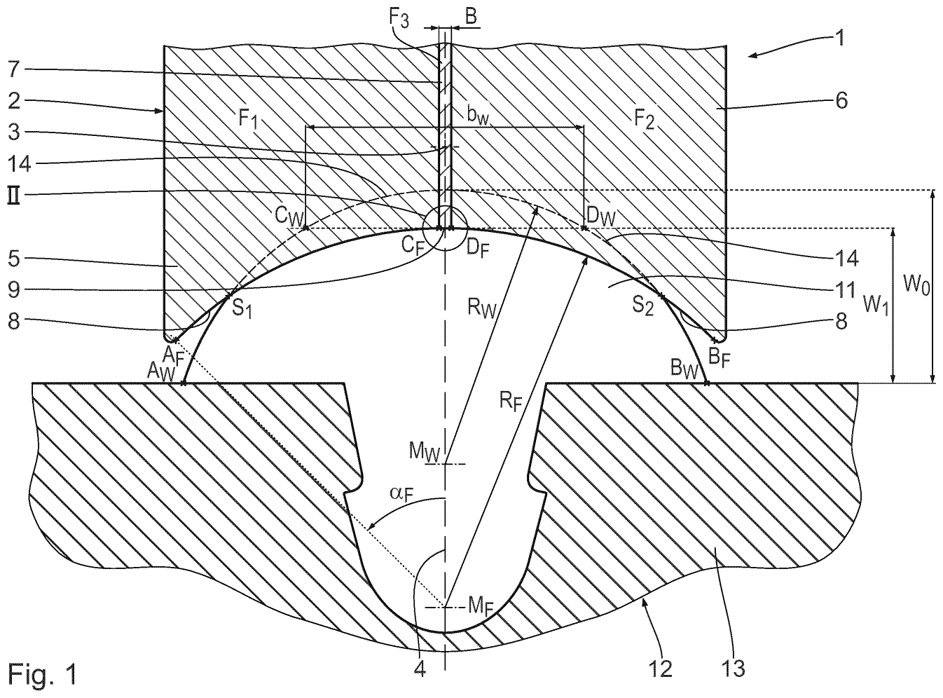

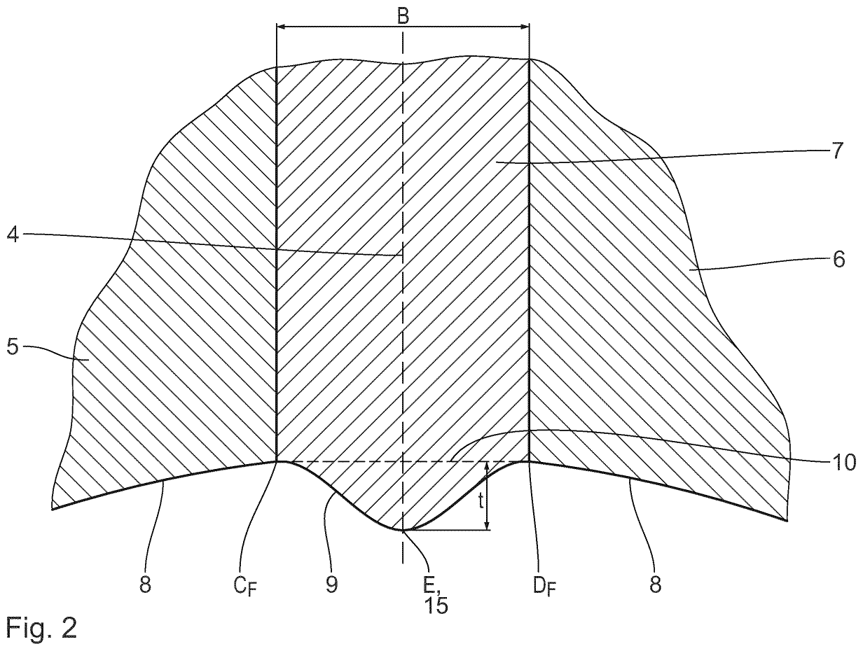

A file shown in FIGS. 1 and 2 as a whole labelled 1 comprises a file base body 2 and a file handle attached to the file base body 2. The file handle is arranged outside the plane of illustration and is not shown in FIG. 1. The file 1 can also be designed without a file handle. The file 1 is then gripped directly on the file base body 2, which can enable more precise work.

The file base body 2 has a longitudinal axis 3 oriented perpendicular to the plane shown in FIG. 1 and a center plane 4 including the longitudinal axis 3.

The file base body 2 is formed by two file elements 5, 6, which are arranged next to each other in the drawing plane shown in FIG. 1. The file elements 5, 6 are made in particular from a tool material, in particular from a steel material and in particular from a tool steel or alternatively from an aluminum material. The file elements 5, 6 are firmly connected to each other, for example glued together. In particular, the respective contact surfaces between the two file elements 5 and 6 serve as bonding surfaces. The bonding can take place over a large area and, in particular, over the entire surface. Such an adhesive connection is stable and, in particular, possible with high positional accuracy of the file elements in relation to each other. In particular, two file elements are firmly connected to each other in pairs.

The file base body 2 has a slot-shaped recess between the two file elements 5, 6. According to the exemplary embodiment shown, the slot-shaped recess extends over the entire drawing area. It is conceivable that the file elements 5, 6 have a common contact surface that lies outside the drawing area. The file elements 5, 6 can be glued together at these contact surfaces. Alternatively, it is conceivable that the file base body 2 with the slot-shaped recess is manufactured in one piece, i.e. consists of only one single file element into which the slot-shaped recess is incorporated.

The file base body 2 is configured to be mirror-symmetrical with respect to the center plane 4. The file base body 2 has a profile-like design, wherein the longitudinal axis 3 corresponds to the profile longitudinal axis. The file elements 5, 6 are designed identically in particular and are arranged mirror-symmetrically to each other with respect to the center plane 4.

The two external file elements 5, 6 have an abrasive machining surface 8, which is used to machine the workpiece. In the exemplary embodiment shown, the abrasive machining surface 8 is formed by a diamond coating.

A depth stop element 7 is arranged on the file base body 2, in particular in the slot-shaped recess. The depth stop element 7 is arranged in particular between the file elements 5, 6 and in particular concentrically with respect to the center plane 4.

The depth stop element 7 has a non-abrasive sliding surface 9, which is in particular designed to be uncoated. The non-abrasive sliding surface 9 is formed in particular by the base material of the depth stop element 7, in particular the steel material and in particular the tool steel, and is in particular designed to be ground and/or polished.

The abrasive machining surfaces 8 are each configured to be concave, in particular continuously, and have a curvature with a radius of curvature R_{F}. The abrasive machining surfaces 8 each have a circular segment contour with the radius R_{F} and extend between the points A_{F} to C_{F} and from

D_{F} to B_{F}. The respective opening angle α_{F} in relation to the center point M_{F} of the curved contour is approximately 45° according to the exemplary embodiment shown. The center point M_{F} is arranged in the center plane 4.

The contour of the non-abrasive sliding surface 9 is shown in particular in the detailed view according to FIG. 2. The contour of the non-abrasive sliding surface 9 is convex at least in sections and in particular completely convex. The non-abrasive sliding surface 9 is configured to be curved and has a kink-free transition to the abrasive machining surfaces 8 at points C_{F} and D_{F}. A virtual connection line 10 is defined by the end points C_{F} and D_{F} of the abrasive machining surfaces 8. In relation to the connection line 10, the non-abrasive sliding surface 9 has a local extremum E, in particular a local maximum, which has a depth distance t in relation to the connection line 10. The depth distance t is orientated perpendicular to the connection line 10. If the local extremum E and a local maximum of the spline spanned by the file elements 5, 6 coincide, small gaps can occur parallel to the longitudinal axis 3 of the file 1. Even with these gaps, a kink-free transition between the abrasive machining surfaces 8 and the non-abrasive sliding surface 9 is provided within the meaning of the application.

The maximum E is arranged in the center plane 4. In particular, the contour of the non-abrasive sliding surface 9 is configured to be mirror-symmetrical to the center plane 4. The maximum E protrudes from the machining surface, in particular from the abrasive machining surfaces 8. The maximum E serves as a depth stop for the file 1, i.e. as a contact line of the file 1 on a workpiece.

The depth stop element 7 and thus the non-abrasive sliding surface 9 have a width B oriented perpendicular to the longitudinal axis 3 and in particular perpendicular to the center plane 4, which is in particular at most 0.3 mm and in particular between 0.01 mm and 0.1 mm.

In FIG. 1, a workpiece 11 is shown below the file 1, which is arranged as a fret bar on the fingerboard region of a stringed instrument, in particular a plucked string instrument 12. The fingerboard region of the plucked string instrument 12 comprises a fingerboard 13. The fret bar 11 has a curved contour with a radius of curvature R_{W} in relation to a center point M_{W}. The center point M_{W}s arranged in the center plane 4. The radius of curvature R_{W} of the fret bar 11 is smaller than the radius of curvature R_{F} of the abrasive processing surfaces 8. When the fret bar 11 is anchored in the fingerboard 13, the original curved outer contour of the fret bar 11 has been flattened. The flattened contour of the fret bar 11 results along the contour points A_{W} to C_{W} with the curvature R_{W}, from C_{W} to D_{W} with a flattened curve, and from D_{W} again with the curvature R_{W} to the end point B_{W}.

The width of the fret bar 11 between the contour end points A_{W} and B_{W}, orientated vertically with respect to the center plane 4 corresponds to the width of the file base body 2 between the contour end points A_{F} and B_{F}.

By flattening the fret bar 11 between the points C_{W} and D_{W}, the original workpiece height Wo was reduced to the flattened workpiece height W₁. The flattened workpiece contour can be rounded using the file 1 by abrasively removing the flanks 14 of the fret bar 11 using the file 1. The flanks 14 are the material regions of the fret bar 11 that protrude from the machining surface 8 and the sliding surface 9. In FIG. 1, the flanks 14 are formed by the contour starting in each case from the intersection points S₁ and S₂ and the contour end points C_{W} and D_{W}. The flanks 14 are successively removed over the entire length of the fret bar 11, wherein the width of the section C_{W}, D_{W} is reduced to the width B. In this region, the file 1 rests with the maximum E on the fret bar 11 and thus prevents unwanted material removal. By tilting the file 1 around the contact edge 15 at the maximum E, i.e. by turning the file 1 clockwise or anti-clockwise at the contact edge 15 as shown in FIGS. 1, 2, the remaining residual fret bar C_{W}, D_{W} can be finally rounded.

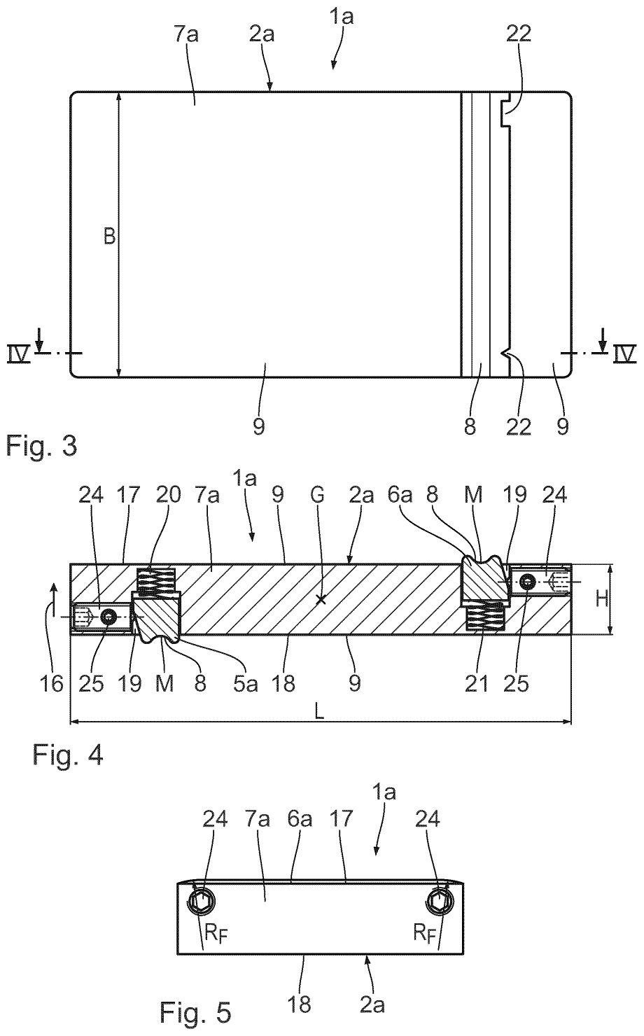

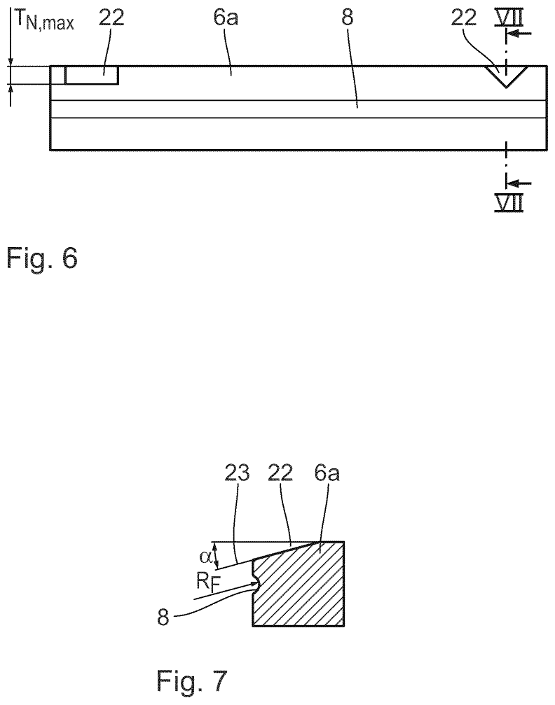

A further exemplary embodiment is described below with reference to FIGS. 3 to 7. Structurally identical parts are given the same reference signs as in the first exemplary embodiment, the description of which is hereby referred to. Structurally different but functionally identical parts are given the same reference signs with a trailing letter a.

A significant difference compared to the first exemplary embodiment is that the file base body 2a of the file la is formed by the depth stop element 7a. The file base body 2a is essentially cuboid in shape and has a length L, a width B and a height H. According to the exemplary embodiment shown, the width B is smaller than the length L. It is advantageous if the width B is determined in dependence on the length of the fret bars to be machined. It is possible to select the width B between 10% and 300% of the fret bar length, in particular between 30% and 200% and in particular between 50% and 100%. The height H extends along a depth direction 16, which is orientated in particular perpendicular to the width B and perpendicular to the length L of the file base body 2a.

The file elements 5a, 6a are arranged on the file base body 2a in such a manner that the longitudinal axis 3 of the file elements 5a, 6a each extend along the width B of the file base body 2a. The file elements 5a, 6a are arranged next to each other along the length L of the file base body 2a. In particular, the file elements 5a, 6a have a file element length along their longitudinal axis 3 that is identical to the width B of the file base body 2a.

The file base body 2a has an upper side 17 and an underside 18, which limit the height H of the file base body 2a. The upper side 17 is arranged at the top in FIG. 4. The underside 18 is arranged at the bottom in FIG. 4. The file base body 2a is point-symmetrical with respect to its center of gravity G. By rotating the file base body 2a by 180° around the center of gravity according to FIG. 4, the upper side 17 and underside 18 are interchanged. The file base body 2a has recesses 19, each of which extends from the upper side 17 or from the underside 18 along the depth direction 16. The recess 19 is not continuous in the depth direction 16 and extends over approximately 50% of the height H of the file base body 2a. The recess 19 is continuous along the width B.

The upper side 17 and the underside 18 are substantially configured to be identical and comprise the two external non-abrasive sliding surfaces 9 and the abrasive machining surface 8 arranged between them in the longitudinal direction L. When machining a fret bar with the respective file element 5a, 6a, the file la can be placed with the sliding surfaces 9 on adjacent fret bars that are not being machined. The sliding surfaces 9 prevent material from being removed from the adjacent fret bars. The file base body 2a has the function of the depth stop element 7a.

A spring receptacle 20 adjoins the recess 19 in the depth direction 16. Along the width direction, multiple spring receptacles 20, in particular two and in particular at least three spring receptacles 20, can be arranged below the recess 19. The spring receptacles 20 are each designed as a cylindrical blind bore. In particular, the spring receptacles 20 are not continuous in the depth direction 16.

A spring element 21 is inserted into each spring receptacle 20, which is axially supported at the base of the spring receptacle in the depth direction 16. According to the exemplary embodiment shown, the spring element 21 is designed as a mechanical spring, in particular as a helical compression spring. The mechanical spring can also be a leaf spring. Other designs of the spring element are also possible, such as an air pressure spring.

The compression spring 21 is dimensioned in such a manner that it protrudes from the spring receptacle 20 in the unloaded state and projects into the recess 19.

A file element 5a, 6a is inserted in the recess 19. Each file element 5a, 6a is arranged with the abrasive machining surface 8, which is designed in particular in the form of a hollow file with a concave contour, on the file base body 2a in such a manner that the concave contour protrudes from the upper side 17 or the underside 18 in each case. The concave contour has a local minimum M in each case. It is particularly advantageous if the local minimum M is set back in the depth direction 16 in relation to the upper side 17 or the underside 18.

The respective file element 5a, 6a is supported on the compression springs 21 on a bottom side opposite the concave contour.

The file elements 5a, 6a have lateral holding grooves 22, which are arranged at a distance from one another along the width direction. The holding grooves 22 are used to hold and/or adjust the file elements 5a, 6a on the file base body 2a. The holding grooves 22 are also referred to as adjustment grooves. According to the exemplary embodiment shown, one adjustment groove 22 is designed with a V-shaped groove profile and the other adjustment groove 22 is designed with a rectangular groove profile. The adjustment groove 22 extends along an inclined groove direction 23, which is inclined at an angle of inclination a relative to the depth direction 16. The adjustment groove 22 has a variable groove depth TN in the depth direction 16, wherein a maximum groove depth T_{N,max} is formed on a surface facing the abrasive machining surface 8.

To hold and finely adjust the respective file element 5a, 6a in the associated recess 19, in particular along the depth direction and in particular against the spring force of the compression spring 21, multiple, in particular in each case two, holding elements 24 are provided for each file element 5a or 6a. The holding elements are designed as fine adjustment screws 24, which in particular have a thread and in particular a fine thread. The fine adjustment screws serve in particular for adjustment, in particular for fine adjustment, of the file elements 5a, 6a against the spring force exerted by the spring element 21. The fine adjustment screws 24 serve in particular for positioning and in particular for fine positioning of the local minimum M on the concave contour of the respective file element 5a, 6a in relation to the depth direction 16. According to the exemplary embodiment shown, the fine adjustment screws 24 are designed as ball-head screws in a grub screw version. On the two opposite end faces, which extend along the height H and the width B, transverse bores with internal threads are arranged, each of which open into the recess 19. The grub screws are screwed into the transverse bore until they engage with their ball head in the respective adjustment groove 22. Due to the fact that at least one adjustment groove 22 is V-shaped, the respective file element 5a, 6a is positioned axially in the width direction and/or along the depth direction 16 and thus fixed. Due to the fact that the other adjustment groove 22 is rectangular or U-shaped, the file elements 5a, 6a have a certain amount of play in the longitudinal direction of the longitudinal axis 3 and thus enable a tolerance, should the respective file element 5a, 6a unintentionally tilt in a small angular range, which is in particular less than 2°, in particular less than 1° and in particular less than 0.5°, during a displacement along the depth direction 16. Such tilting could be briefly compensated for by the aforementioned tolerance in the axial direction, so that in particular undesired jamming of the file element 5a, 6a on the file base body 2a is prevented.

For the fine adjustment screws 24 to be operated, they have an internal hexagon socket opening at their rear end. It is also conceivable that the fine adjustment screws 24 are not designed as grub screws.

To secure the fine adjustment screws 24, additional locking grub screws 25 can be used, which extend in particular in the width direction and can be screwed in through the respective fine adjustment screw 24, in particular transversely to the screw-in direction of the respective fine adjustment screw 24. For this purpose, the respective fine adjustment screw 24 has a through opening with an internal thread that corresponds to the external thread of the locking grub screw 25.

The fine adjustment screw 24 enables immediate and direct fine adjustment of the position of the file elements 5a, 6a relative to the file base body 2a along the depth direction 16. Such fine adjustment may be necessary in particular due to manufacturing tolerances, in particular during the production of the file elements 5a, 6a.

The concave contour of the machining surface 8 is in particular arc-shaped and in particular designed as a pitch circle with an arc length smaller than that of a semicircle with a constant radius of curvature RF. The fact that the arc length is smaller than that of a semicircle ensures that the file element 5a, 6a does not rest on the fingerboard and could therefore prevent complete machining of the workpiece. The arc length is in particular less than 180°, in particular at most 175°, in particular at most 170°, in particular at most 165° and in particular at most 145°. In particular, the respective file element 5a, 6a is rounded in the width direction on the end face with the radius of curvature R_{F} towards the side edges.

According to a further exemplary embodiment not shown in the drawing, which substantially corresponds to the previous exemplary embodiment according to FIGS. 3 to 7, the at least one file element 5a, 6a has a flat machining surface 8. The machining surface 8 is therefore in particular not concave and not convex. The machining surface 8 is not curved.

The at least one file element is arranged on the file base body in such a manner that the machining surface is arranged flush with the surface of the file base body. This means that the abrasive machining surface lies in a plane defined by the sliding face of the file base body.

Such a file can be used in particular for repairing a single fret bar if this single fret bar is inserted on the fingerboard between other fret bars, wherein these other fret bars have already been rounded. With the file described here, pre-machining is possible by means of the flat file element, wherein finishing is carried out in particular by means of a file according to the first exemplary embodiment in FIGS. 1 and 2.

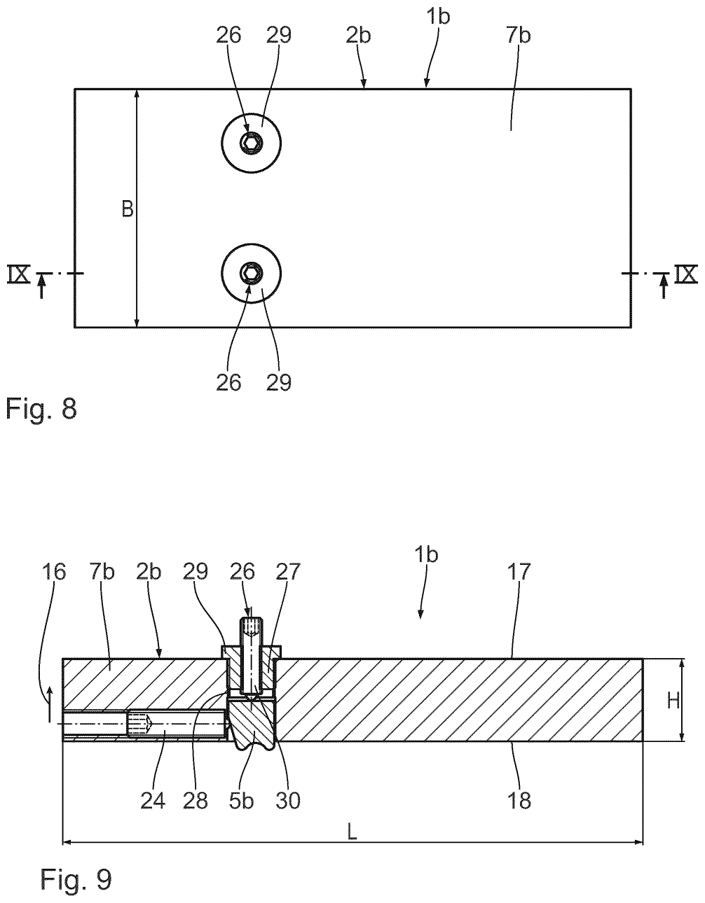

A third exemplary embodiment is described below with reference to FIGS. 8 and 9. Structurally identical parts are given the same reference signs as in the first two exemplary embodiments, the description of which is hereby referred to. Structurally different but functionally identical parts are given the same reference signs with a trailing letter b.

A significant difference compared to the previous exemplary embodiment is that the position of the file element 5b is adjusted by means of a fine adjustment screw 26. In particular, two fine adjustment screws 26 are arranged at a distance from one another along the width B and are used for fine adjustment of the file element 5b in the depth direction 16. Tilting of the file element 5b with its longitudinal axis 3 relative to the plane defined by the underside 18 is thus excluded. The fine adjustment screw 26 comprises a sleeve-like receptacle 27 with an external thread, which can be screwed into a corresponding internal thread of a screw receptacle 28 in the file base body 2b. The fine adjustment screw is thus reliably arranged on the file base body 2b and fixed thereto.

A radially protruding fret stop 29, which projects from the upper side 17 of the file base body 2b, is provided as an integral part of the sleeve receptacle 27. The fret stop 29 has an outer diameter that is larger than an inner diameter of the screw receptacle 28. The sleeve receptacle 27 has a through bore with an internal fine thread into which a pin 30 of the fine adjustment screw 26 can be screwed with a corresponding external fine thread. The pin 30 has a ball head and can be screwed into the bottom wall of the file element 5b in the depth direction 16 up to the stop. The fine adjustment screw 26 enables immediate and direct fine adjustment of the position of the file element 5b in relation to the file base body 2b along the depth direction 16. Such fine adjustment may be necessary in particular due to manufacturing tolerances, in particular during the production of the file element 5b.

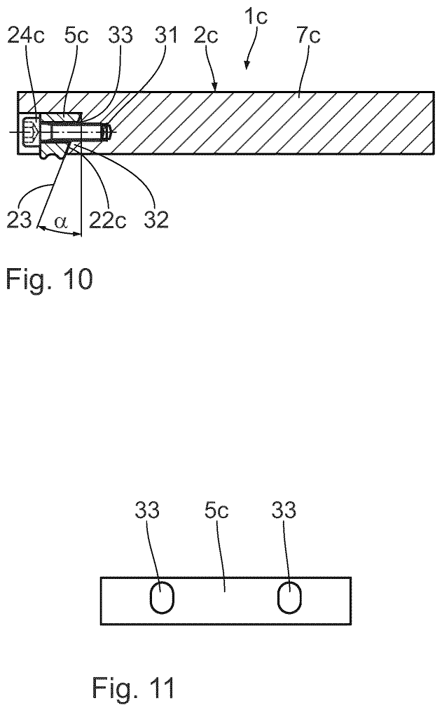

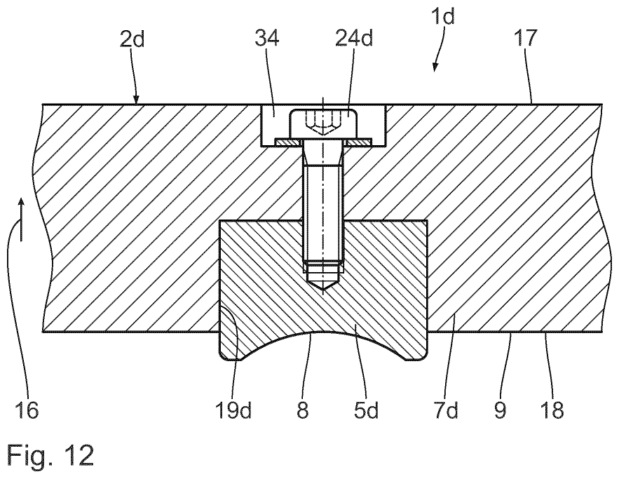

A fourth exemplary embodiment is described below with reference to FIGS. 10 and 11. Structurally identical parts are given the same reference signs as in the previous exemplary embodiments, the description of which is hereby referred to. Structurally different but functionally identical parts are given the same reference signs with a trailing letter c.

A significant difference compared to the previous exemplary embodiments is that the file element 5c is fixed directly to the file base body 2c of the file 1c. The holding element 24c, which is designed as a through bolt, is used for this purpose. The holding element 24c can be designed as a screw with a metric thread and an internal hexagon screw head, a so-called Allen screw. A corresponding fastening thread 31, which is designed as a blind bore with an internal thread, is arranged on the file base body 2c for each holding element 24c. In particular, fastening threads 31 that are spaced apart from one another in the width direction 2 are arranged on the file base body 2c.

A further difference compared to the previous exemplary embodiments is that in the file element 5c, the holding grooves 22 are formed on a side wall facing away from the holding element 24c, in particular arranged opposite thereto. Projections 32 corresponding to the holding grooves 22c are formed on the file base body 2c, in particular in one piece. The holding grooves 22c and the corresponding projections 32 are each inclined by the angle of inclination a relative to the depth direction 16. The file element 5c can be moved along the groove direction 23 relative to the file base body 2c.

In the exemplary embodiment shown, the file element 5c can also be designed without a holding groove 22c and corresponding projections 32. The frictional connection generated by the holding elements 24c between the file element 5c and the file base body 2c prevents axial displacement of the file element 5c along the longitudinal axis 3.

In order to simplify this flexible positioning of the file element 5c on the file base body 2c, the through openings 33 in the file element 5c are designed in particular in the depth direction 16 with a clear width b that is larger than the outer diameter of the holding element 24c. In principle, it is conceivable that the through opening 33 is configured to be circular. According to the exemplary embodiment shown, the through opening 33 is substantially elongated with a longitudinal extension in the depth direction 16. The clear width a in the width direction B is in particular smaller than the clear width b in the depth direction 16. This makes it possible for the file element 5c to be variably fixed in the width direction by the holding elements 24c. The assembly of the file element 5c on the file base body 2c is simplified. In particular, the elongated through openings 33 make it possible to compensate for manufacturing tolerances during the production of the file element 5c and/or the file base body 2c. In particular, the holding elements 24c are arranged without play in the through openings 33 in the width direction.

Precise adjustment of the file element is achieved here by steel foils, not shown in detail, which are positioned and clamped at suitable points between the surface of the file element 5c opposite the machining surface 8 and the corresponding surface of the file base body 2c.

Another exemplary embodiment is described below with reference to FIG. 12. Structurally identical parts are given the same reference signs as in the previous exemplary embodiments, the description of which is hereby referred to. Structurally different but functionally identical parts are given the same reference signs with a trailing letter d.

A significant difference compared to the previous exemplary embodiments is that the file element 5d is held directly by the holding element 24d in the depth direction 16. The holding element 24d is arranged as a fastening screw in a cutout 34 provided for this purpose on the upper side 17 and extends along a through opening in the depth direction 16 as far as the recess 19d in which the file element 5d is arranged. On its bottom side opposite the concave machining surface 8, the file element 5d has a receiving bore with an internal thread that corresponds to the external thread of the holding element 24d.

Precise adjustment of the file element is achieved using steel foils, as in the previous exemplary embodiment.

Multiple holding elements 24d can be provided along the width direction. The design of the file 1d and in particular the attachment of the file elements 5d to the file base body 2d is particularly uncomplicated.

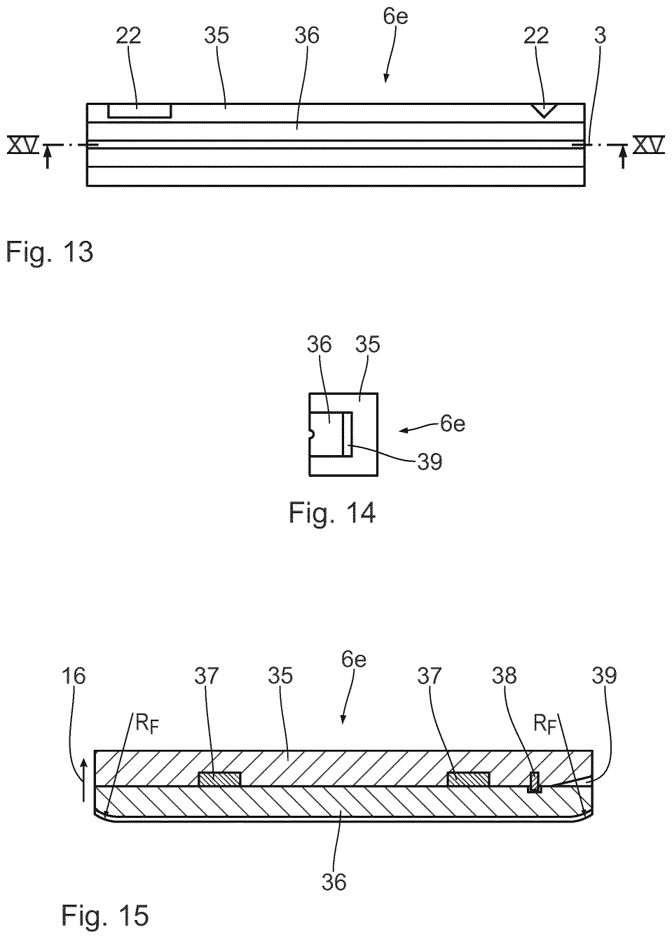

A further exemplary embodiment is described below with reference to FIGS. 13 to 15. Structurally identical parts are given the same reference signs as in the previous exemplary embodiments, the description of which is hereby referred to. Structurally different but functionally identical parts are given the same reference signs with a trailing letter e.

A significant difference compared to the previous exemplary embodiments is that the file element 6e is made in multiple pieces. The file element 6e comprises a file holding element 35 and a file insert element 36 held by the file holding element 35.

The file holding element 35 is substantially designed as an open rectangular hollow strip, i.e. substantially U-shaped in particular. The file insert element 36 is inserted into the file holding element 35 and held in the depth direction 16 by means of at least one holding element 37. According to the exemplary embodiment shown, multiple, in particular two, holding elements 37 are present. The holding elements 37 are designed in particular as permanent magnets, which are arranged in particular in the base of the recess of the file holding element 35 and are integrated in particular in the file holding element 35. In particular, the file insert element 36 is made of a ferromagnetic material and is held in the file holding element 35 by the magnetic holding elements 37.

It is advantageous that the file insert element 36 can have a geometrically uncomplicated design. The production of the file insert element 36 is simplified.

The holding grooves 22 provided for the connection with the file base body 2 are designed on the file holding element 35.

In order to ensure axial fixation along the longitudinal axis 3 of the file insert element 36 on the file holding element 35, a locking pin 38 orientated in the depth direction 16 is arranged to connect the file insert element 36 to the file holding element 35. The locking pin 38 also serves in particular to absorb shearing forces that can occur along the longitudinal axis 3 during workpiece machining.

It is advantageous if an indentation 39 is arranged in an edge region of the file element 6e and in particular in the region of a parting plane between the file holding element 35 and the file insert element 36. The indentation 39, in particular of wedge-shaped design, serves as a tool opening, in particular for applying a lever tool in order to separate the file insert element 36 from the file holding element 35 against the magnetic holding force.

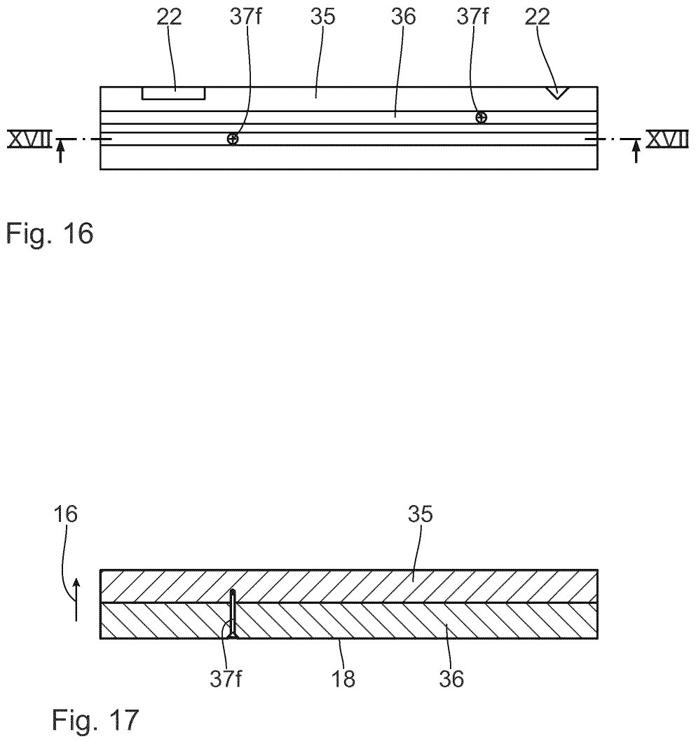

Another exemplary embodiment is described below with reference to FIGS. 16 and 17. Structurally identical parts are given the same reference signs as in the previous exemplary embodiments, the description of which is hereby referred to. Structurally different but functionally identical parts are given the same reference signs with a trailing letter f.

This exemplary embodiment essentially corresponds to the previous exemplary embodiment, wherein the file element 6f is designed with file holding element 35 and file insert element 36. Cross screws, which extend along the depth direction 16, serve as holding elements 37f in order to ensure a connection between the file insert element 36 and the file holding element 35. In particular, the file insert element 36 has a through bore and the file holding element 35 has an internal fastening thread that corresponds to the external thread of the holding screw 37f.

In particular, the screws 37f are arranged outside the curved workpiece machining region on the file insert element 36. In particular, the holding screws 37f are designed as countersunk screws and are set back in relation to the outer surface 18. This ensures that the workpiece machining is not negatively impaired due to the screw connection.

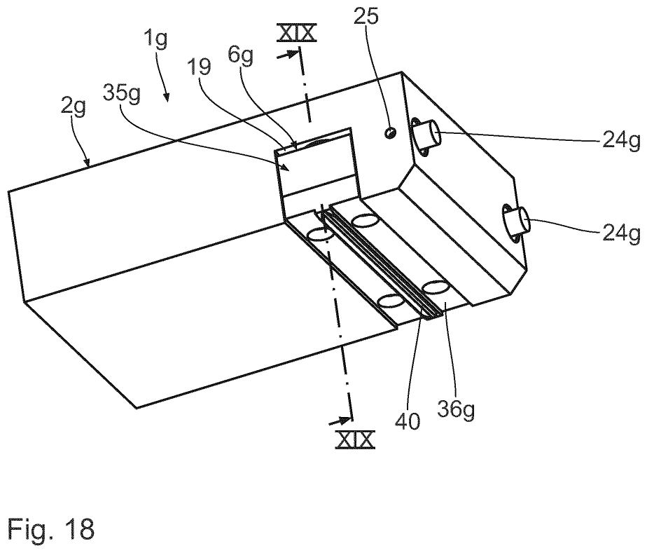

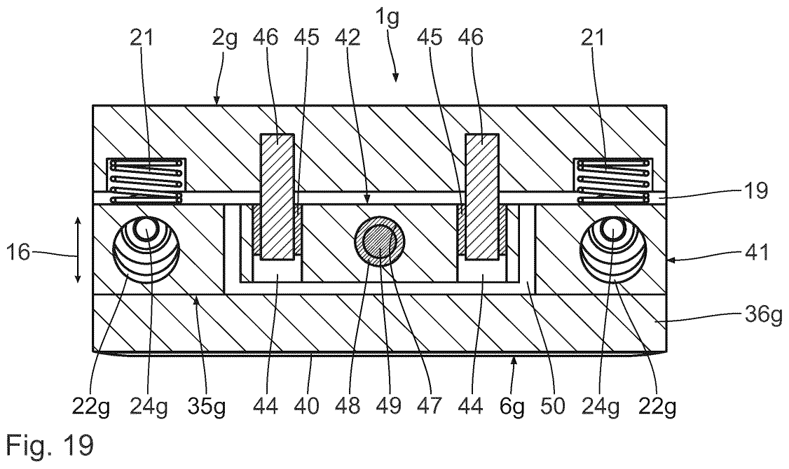

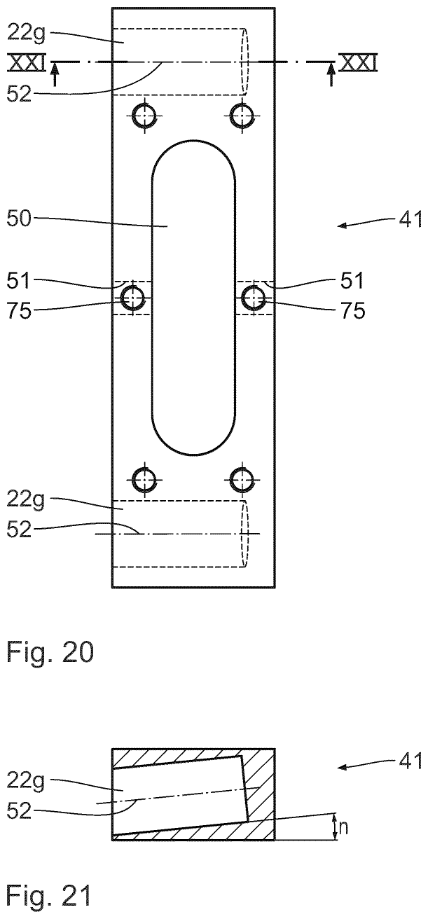

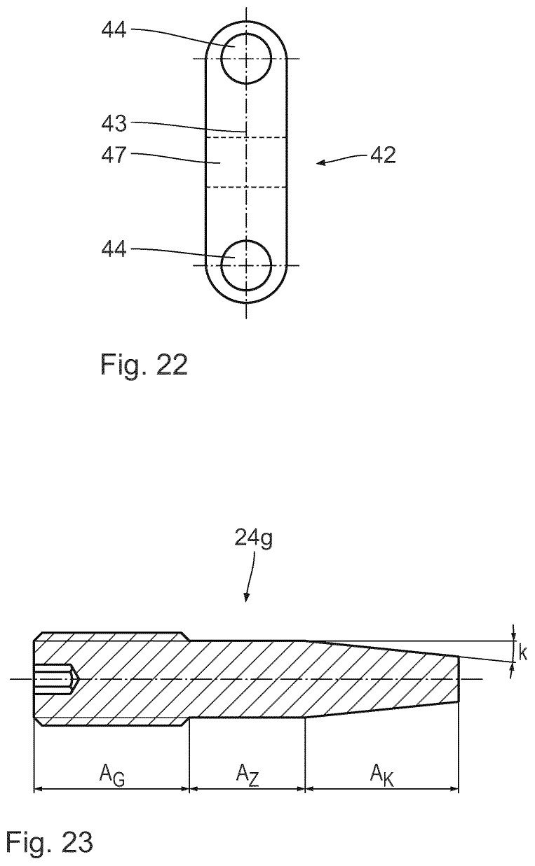

A further exemplary embodiment is described below with reference to FIGS. 18 to 23. Structurally identical parts have the same reference signs as in the previous exemplary embodiments, the description of which is hereby referred to. Structurally different but functionally identical parts have the same reference signs with a trailing letter g.

In the file 1g, the file element 6g has a multi-piece design with the file insert element 36g, which is held on the file holding element 35g, in particular screwed thereon.

The file insert element 36g is made in one piece and has a protruding, strip-like machining web 40. The machining web 40 comprises the abrasive machining surface 8. The machining web 40 is designed with a concave surface.

The file insert element 36g has multiple through-bores, four according to the exemplary embodiment shown. Holding screws for fastening the file insert element 36g to the file holding element 35g can be screwed through the through-bores.

The file holding element 35g is designed in multiple pieces and comprises a file holding element receptacle 41 and a file holding element guide 42. The file holding element guide 42 is designed in the shape of a web and has a rectangular and in particular square cross-sectional area in a plane perpendicular to a web longitudinal axis 43.

In a direction perpendicular to the web longitudinal axis 43, the file holding element guide 42 has two guide bores 44, into each of which a sliding bush 45 can be inserted. In particular, the guide bores 44 are continuous, i.e. they extend over the entire height of the file holding element guide 42. A dowel pin 46 is inserted into each of the sliding bushes 45 and is held in a recess in the file base body 2g. The dowel pins 46 are orientated on the file 1g along the depth direction 16. The file holding element guide 42 can be displaced along the dowel pins 46, i.e. along the depth direction 16, on the dowel pins 46, in particular relative to the file base body 2g.

Compression springs 21 are arranged on an underside of the file holding element receptacle 41. The compression springs 21 are arranged preloaded between the file base body 2g and the file holding element 35g so that an actuating force is exerted on the file holding element 35g in such a manner that it is pressed away from the file base body 2g out of the recess 19.

The file holding element guide 42 has a transverse through-bore 47, into which a transverse plain bearing bush 48 with a transverse pin 49 is inserted. The transverse through-bore 47 is orientated in a direction that is perpendicular to the web longitudinal axis 43 and perpendicular to the guide bores 44. The file holding element guide 42 is held in the file holding element receptacle 41 by the transverse pin 49 mounted in the transverse plain bearing bush 48. The file retaining element receptacle 41 is rotatable about the transverse pin 49 on the file holding element guide 42, i.e. it is articulated. For this purpose, the file holding element receptacle 41 has an elongated hole-shaped cutout 50. In a plane perpendicular to the guide bores 44, the file holding element guide 42 has an outer contour corresponding to the elongated hole-shaped cutout 50. The file holding element receptacle 41 has four threaded bores on its upper side facing the file insert element 36g, which correspond to the fastening openings on the file insert element 36g. To accommodate the transverse pin 49, the file holding element receptacle 41 has aligned transverse bores 51 arranged opposite the cutout 50. A threaded bore 75 is arranged in a vertical direction with respect to each transverse bore 51. A grub screw, not shown, can be screwed into the threaded bore 75 in order to fix the transverse pin 49 in the respective transverse bore 51. For this purpose, the transverse pin 49, which has a cylindrical basic shape, can be flattened at least in sections.

Two holding grooves 22g are provided on one side wall of the file holding element receptacle 41. The holding grooves 22g are configured to be cylindrical. The holding grooves 22g can also have a non-circular inner contour, which can in particular be configured to be rectangular in a plane perpendicular to the groove longitudinal axis 52. The holding grooves 22g are designed as blind bores. The borehole longitudinal axis 52 is inclined at an angle of inclination n relative to a transverse axis of the transverse bore 51. The angle of inclination n is in particular less than 10°, in particular between 2° and 8°, in particular between 4° and 7° and in particular between 5° and 6°. In particular, the angle of inclination n is 5.7°.

A holding element 24g engages in each of the holding grooves 22g. The holding element 24g is shown enlarged. The holding element 24g is an adjustment screw with a threaded section A_{G}, a cylinder section A_{Z} and a cone section A_{K}. The external thread of the threaded section A_{G} corresponds to a corresponding internal thread in a through opening in the file base body 2g. A locking grub screw 25 can be arranged in a transverse bore orientated towards it in order to secure the axial positioning of the holding element 24g in the file base body 2g.

The cylinder section A_{Z} has a core diameter that is smaller than the thread diameter of the threaded section A_{G}. Starting from the core diameter of the cylinder section A_{Z}, the cone section A_{K} has an outer cone angle k, which corresponds in particular to the angle of inclination of the holding groove 22g and is in particular identical to the angle of inclination n. With the holding element 24g, which is designed as a fine adjustment screw, it is possible to adjust the file element 6g on the file base body 2g along the depth direction 16 with a precision of 1/1000 mm to 5/10000 mm.

In particular, the use of the sliding bushes 45 and the dowel pins 46 improves the adjustment of the file element 6g, as the sliding faces between the dowel pins 46 and sliding bushes 45 are better protected against dust and chips. The displacement is possible in a more precise manner, in particular with a higher resolution. A horizontal load on the holding elements 24g and the corresponding bores in the file base body 2g, in particular in the working direction, is reduced and in particular is negligibly low.

Manufacturing and/or assembly tolerances of individual components can be compensated for in a targeted manner in the movement plane of the file holding element 35g. It has been recognized that tolerances in the range of 1/100 mm to 3/100 mm occur in the manufacture of the machining web 40 due to wire erosion or fine milling and/or due to an unevenly thick coating with abrasive materials. When the file insert element 36g is exchanged, a change in the zero position of the adjustment may be required, in particular with regard to the production of a machining web 40 aligned perpendicular to the depth direction 16 and with regard to a deepest position of the machining web 40 in the depth direction 16. Readjustments may also be required due to abrasion-related changes in the layer thickness of the abrasive material of the machining web 40. In the exemplary embodiment shown, the readjustments are possible with the controlled file holding element guide 42 in the depth direction 16 and in particular due to the axially mounted, tiltable file insert element receptacle and the fine adjustment.

Due to the fact that the holding element 24g has a cone section A_{K}, there is no point contact in the holding groove 22g, but rather line contact. The pressure between the holding element 24g and the holding groove 22g is therefore reduced. This results in a more even load and wear between the adjustment screw as holding element 24g and the adjustment opening as holding groove 22g.

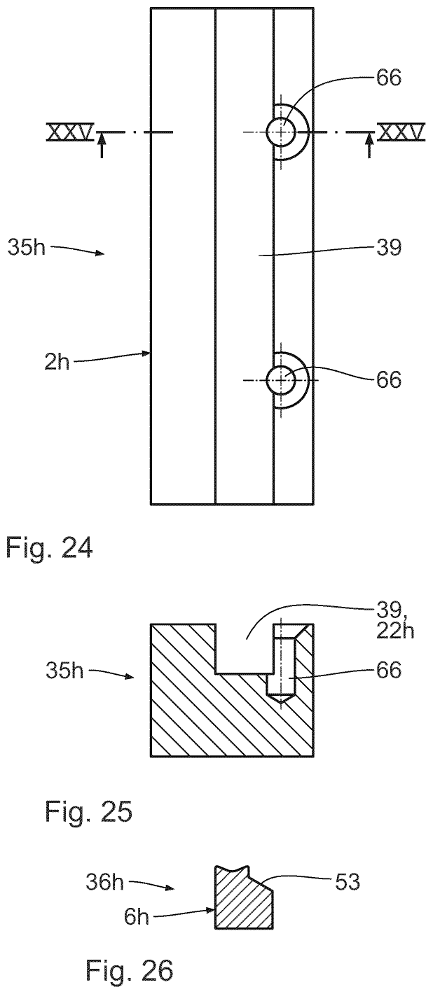

A further exemplary embodiment is described below with reference to FIGS. 24 to 26. Structurally identical parts have the same reference signs as in the previous exemplary embodiments, the description of which is hereby referred to. Structurally different but functionally identical parts have the same reference signs with a trailing letter h.

Compared to the previous embodiment example, there is a change in that the file holding element 35h is designed in one piece.

The file insert element 36h can be inserted into the cutout 39 provided for this purpose in the file holding element 35h. Two threaded bores 66 are formed laterally next to the cutout 39, into each of which a holding screw 37h can be screwed and can engage on a shoulder 53 provided for this purpose on the file insert element 36h. The file insert element 36h is clamped to the file holding element 35h by means of holding screws not shown. The attachment and, in particular, the detachment of the file insert element 36h from the file holding element 35h is uncomplicated. The file holding element 36h can be replaced quickly and time-efficiently.

A further difference is that the file holding element 35h has only a single holding groove 22h, which is arranged in particular in the center of the file base body 2h or the file holding element 35h in the machining direction. Accordingly, an articulated mounting of the file holding element 35h according to the previous exemplary embodiment is dispensable.

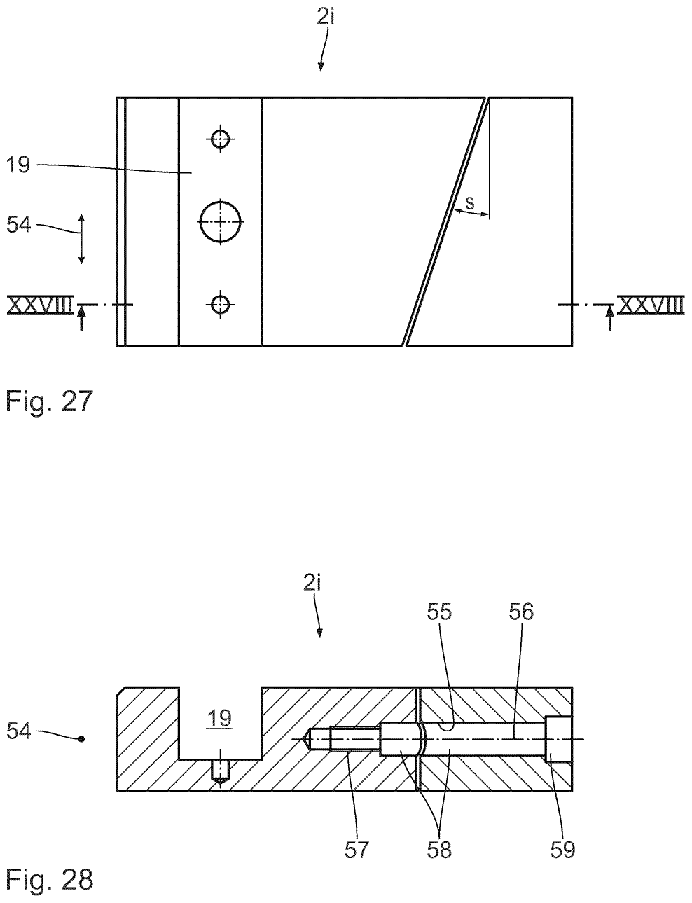

Another exemplary embodiment is described below with reference to FIG. 27 and FIG. 28. Structurally identical parts have the same reference signs as in the previous exemplary embodiments, the description of which is hereby referred to. Structurally different but functionally identical parts have the same reference signs with a trailing letter i.

In the file, the file base body 2i is designed in two pieces, wherein a first file base body part, in which the recess 19 is formed, and a second file base body part are arranged in such a manner that a closed file base body 2i is formed. The parting plane extends transversely to the machining direction 54 at an inclined angle s, which is in particular between 1° and 45°, in particular between 2° and 30° and in particular between 5° and 15°. The parting surfaces of the first file base body part and the second file base body part facing the parting plane correspond to each other. In particular, the parting surfaces are each designed to be flat and enable uncomplicated positioning of the file base body parts relative to one another.

Two transverse bores 55 are arranged on one end face of the file base body 2i for the length-adjustable design of the file base body 2i. For this purpose, the transverse bores 55 each have an internal threaded section 57 along the borehole longitudinal axis 56, an adjoining fitting section 58 and an external cutout section 59 that is open towards the end face. A correspondingly manufactured fitting screw can be screwed into the thread of the threaded section 57 and enables a reliable and precise connection of the file holding element parts to each other, in particular in such a manner that the parting surfaces of the file holding element parts touch each other. It is conceivable to provide various second file base body parts with different length dimensions for the first file base body part in order to be able to form file base bodies 2i of different lengths. This makes it possible to variably adjust the file base body with different length dimensions.

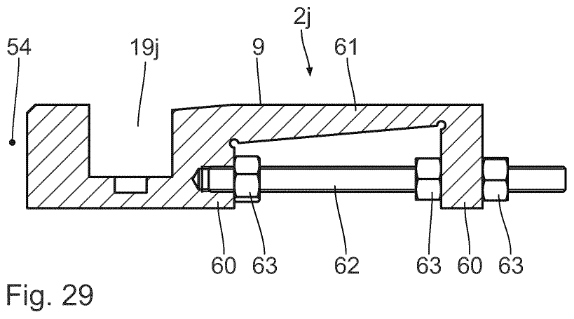

A further exemplary embodiment is described below with reference to FIG. 29. Structurally identical parts have the same reference signs as in the previous exemplary embodiments, the description of which is hereby referred to. Structurally different but functionally identical parts are given the same reference signs with a trailing letter j.

Compared to the previous exemplary embodiment, the file base body 2j enables the targeted adjustment of a deformation of the non-abrasive sliding surface 9, in particular in a region laterally adjacent to the recess 19j, into which a file holding element with a file insert element can be inserted. This makes it possible to design the file base body 2j in a surface region with a convex or concave curvature.

This is achieved in particular by the fact that the file base body 2j is designed in a portal-like manner in a plane orientated perpendicular to the machining direction 54, with two opposing web walls 60 and a ceiling wall 61 connecting the web walls 60. The sliding surface 9 is arranged on the ceiling wall 61. Relief notches can be arranged on an underside of the ceiling wall 61 opposite the sliding surface 9, in particular in the transition region to the web walls 60, in order to reduce and in particular avoid stress peaks in the file base body 2j.

In a lower base region at a distance from the ceiling wall 61, the web walls 60 are mechanically connected to each other by means of a tension/compression element 62, in particular in the form of a threaded rod. The tension/compression element 62 is fixed in an internal threaded bore on one of the web walls 60 and is additionally held in place by an additional translation element 63 in the form of a nut. The threaded bore is designed as a blind bore.

On the opposite web wall 60, which has a through-opening, the tension/compression element is guided through the through-opening and secured with two fastening elements 63, which are arranged opposite each other on the through-opening. The tension/compression element 62 can be used to exert tensile or compressive forces on the web walls 60. The tension/compression element 62 enables a mechanical coupling of the web walls 60. When a tensile force is exerted, a convex curvature is formed on the non-abrasive sliding surface 9. When a compressive force is exerted on the web walls 60, a concave curvature is formed on the non-abrasive sliding surface 9.

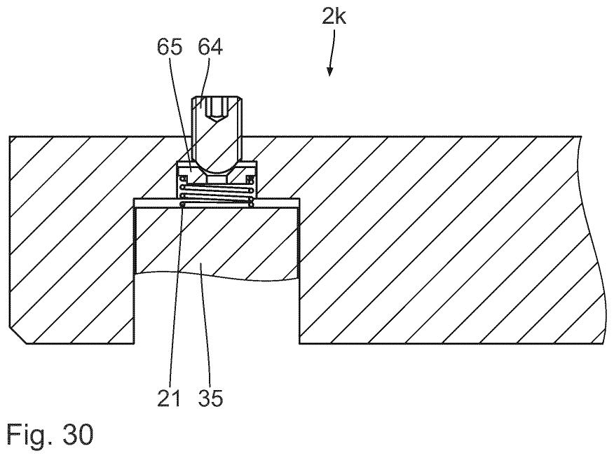

Another exemplary embodiment is described below with reference to FIG. 30. Structurally identical parts have the same reference signs as in the previous exemplary embodiments, the description of which is hereby referred to. Structurally different but functionally identical parts are given the same reference signs with a trailing letter k.

The file base body 2k has a preloading element 64, which can be screwed as a translation screw into an opening provided for this purpose on an underside of the file base body 2k. The loading element 64 interacts with an adjustment element 65 in the form of a perforated disc, which is arranged on an underside of the compression spring 21, i.e. opposite the file holding element 35. Depending on the screw-in depth of the loading element 64, the adjustment element 65 is displaced and thus the depth of the cutout for the compression spring 21 is reduced, i.e. the preload on the compression spring 21 is increased. With the loading element 64 and the adjustment element 65, it is possible in particular to variably adjust the preload that can be provided with the compression spring 21.

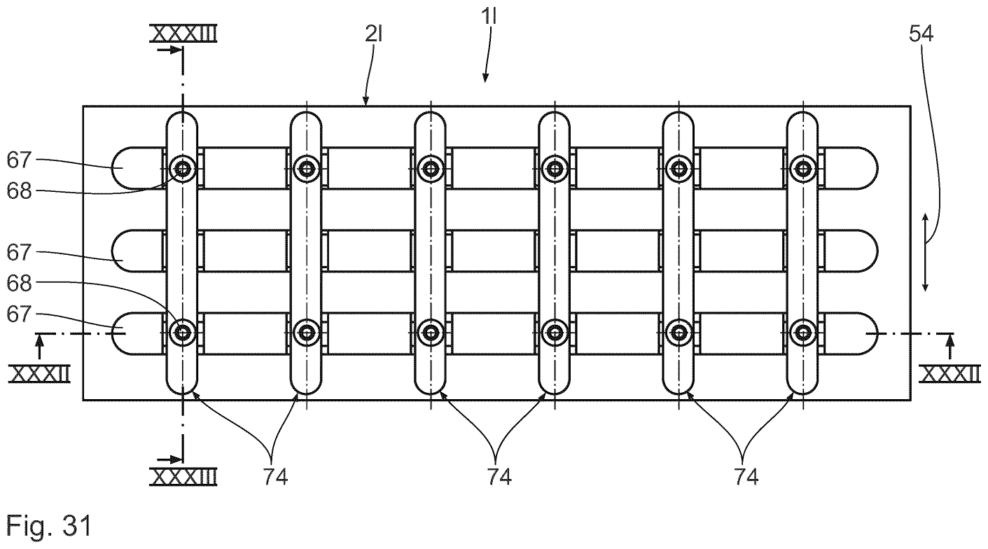

A further exemplary embodiment is described below with reference to FIGS. 31 to 33. Structurally identical parts have the same reference signs as in the previous exemplary embodiments, the description of which is hereby referred to. Structurally different but functionally identical parts have the same reference signs with a trailing letter l.

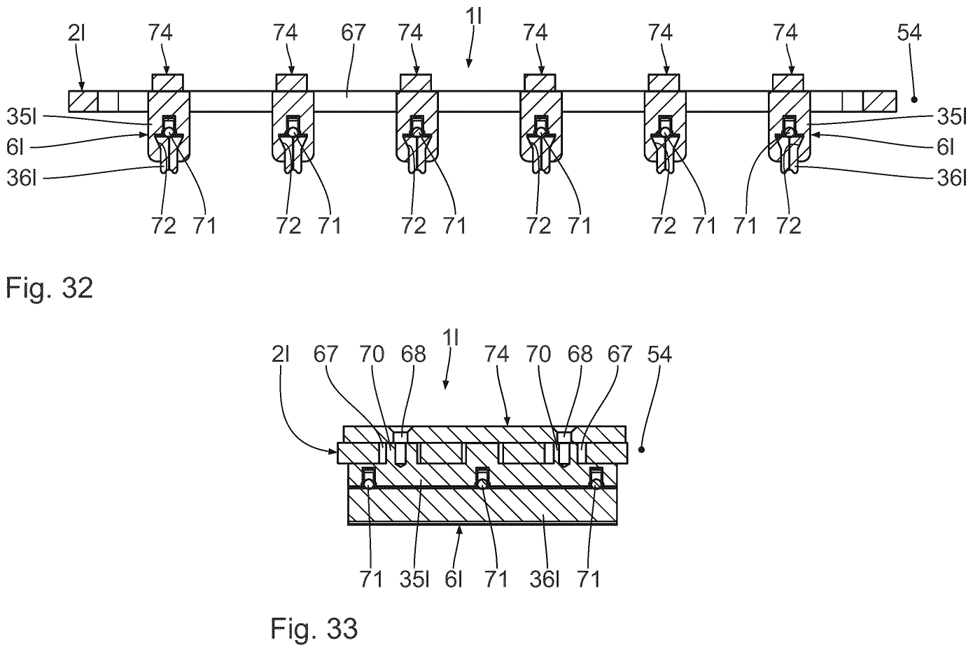

The file base body 2l has at least one guide slot 67, in particular multiple guide slots 67 and in particular three parallel orientated guide slots 67, which serve to accommodate the file elements 6l. In the longitudinal direction of the guide slots 67, fret bar distance markings and/or internal dowel pins, which are arranged in corresponding bores or guide bushes in the file base body 2l, can be present, which simplify positioning of the file elements 6l at defined distances with respect to the longitudinal direction. In particular, this makes it possible to arrange the file elements 6l next to each other in the longitudinal direction in such a manner that different fret bars can be machined simultaneously with the file 1l. For reasons of visualization, the file elements 6l are shown in FIGS. 31 and 32 arranged at the same distance from one another along the longitudinal slots 67. When the file elements 6l are arranged according to the scale length, the distances between two adjacent file elements 6l are correspondingly different. In order to facilitate the positioning of the file elements 6l, markings may also be provided on each of the file elements 6l. It is understood that several markings can be made on the file base body 2l, in particular for different scale lengths.

The file elements 6l each have a file holding element 35l and a file insert element 36l.

The file 1l enables simultaneous machining of multiple fret bars on one instrument. In particular, the file elements 6l can be fixed to the file base body 2l in a variable manner relative to one another. The file elements 6l are each clamped to the file base body 2l by the file holding element 35l via an abutment 74. Each file element 6l has fastening webs 70 projecting into the guide slots 67 on its file holding element 35l, in each of which fastening webs 70 two clamping screws 68 engage. At least one spring element 71 is arranged on the file holding element 35l on an underside opposite the fastening webs 70. In particular, two spring elements 71 are present and are each designed as a resilient pressure piece, in particular in the form of pressure spring screws, with a spring-mounted pressure ball that engages in a corresponding recess in the file insert element 36l. The spring elements 71 can be pressed or screwed into the respective recess. The spring movement of the file insert element 36l is retained. Its sliding out of the file holding element 35l is prevented by a combined positive and frictional locking.

Alternatively, it is possible to design the spring element 71 as a flat spring with which the file insert element 36l is supported on the file holding element 35l. The flat spring is fastened, in particular screwed, riveted and/or welded, to an underside opposite the fastening webs 70 and can have an undulating contour in a plane perpendicular to the longitudinal direction of the guide slots 67. The contour protrudes at at least one point into a corresponding recess in the file insert element 36l, so that a corresponding positive locking is achieved for the spring element.

The spring element 71 exerts a clamping force on the file insert elements 36l, which holds the file insert elements 36l positively locked and friction-locked in the file holding element 35l.

It is advantageous if the file base body 2l has sufficient flexibility, in particular parallel to the long side of a fingerboard, i.e. perpendicular to the machining direction. In particular, this makes it possible to adapt the file base body 2l to an uneven instrument neck.

The file insert elements 36l are designed in particular analogously to the file element of the first exemplary embodiment. In particular, the depth stop function of these file elements 6l is not dependent on adjacent fret bar levels, but is oriented exclusively to the level of the fret bar to be machined, i.e. directly. Fine adjustment of the file elements 6l on the file base body 2l is not necessary with the file 1l. In particular, differences in height of the non-abrasive crest lines can be compensated for by springing in the file insert elements 36l by means of the spring elements 71. The height differences can be caused by manufacturing tolerances and/or by different stock removal rates on different fret bars during their simultaneous machining.

The file insert elements 36l provided with a dovetail are guided along the machining direction 54 in particular by means of a corresponding dovetail guide 72 within the file holding elements 35l.

Impermissible displacements of the file insert elements 36l along the machining direction 54 can also be prevented by mechanical stop elements, not shown, arranged along the machining direction 54 of the file base body 2l at the front and rear of the file base body 2l and/or on the file holding element 35l. In particular, fixed stop elements are provided. In particular, the removable stop element is fastened to the file base body 2l and/or to the file holding element 35l. Additionally or alternatively, recesses may be provided in the file insert element 36l, which allow the spring element 71 to engage.

The stop elements are designed in particular as flat-head screws, the heads of which are ground straight on one side to approximately one third of the head diameter and prevent the file insert element 36l from being pulled out or pushed out, in particular with the round part of the flat head. In order not to hinder spring movements of the file insert element 36l, the undersides of the screw heads can each have a distance of approximately 0.1 mm to 0.2 mm from the file insert element 36l in this position.

1-15. (canceled).

16. A file for creating a non-planar contour on a workpiece, the file comprising:
a longitudinal axis,
at least one file element with an abrasive machining surface,
a depth stop element with a non-abrasive sliding surface,
wherein at least one file element and the depth stop element are arranged next to one another in a plane orientated perpendicular to the longitudinal axis.

17. The file according to claim 16, wherein the file has a transverse curvature.

18. The file according to claim 16, wherein at least one file element and the depth stop element are connected to each other.

19. The file according to claim 18, wherein at least one file element and the depth stop element are connected to each other in pairs.

20. The file according to claim 16, wherein the abrasive machining surface is designed to be concave.

21. The file according to claim 16, wherein the abrasive machining surface has a curvature with a radius of curvature.

22. The file according to claim 21, wherein the radius of curvature is greater than an original radius of curvature of the workpiece.

23. The file according to claim 16, wherein at least one file element is profiled along the longitudinal axis.

24. The file according to claim 16, wherein at least one of the contour of the machining surface and the sliding surface is constant along the longitudinal axis.

25. The file according to claim 16, wherein the depth-stop element forms a file base body on which at least one recess for inserting the at least one file element is arranged.

26. The file according to claim 25, comprising a holding element for holding the at least one file element.

27. The file according to claim 26, wherein the holding element is designed for holding the at least one file element in at least one recess.

28. The file according to claim 25, wherein at least one file element has an adjustment groove.

29. The file according to claim 25, wherein at least one file element has an adjustment groove for holding engagement of the holding element.

30. The file according to claim 29, wherein the adjustment groove extends along the depth direction of the file.

31. The file according to claim 28, wherein the adjustment groove has a variable groove depth in the depth direction of the file.

32. The file according to claim 28, wherein the adjustment groove has a V-shaped groove profile in a plane perpendicular to the depth direction.

33. The file according to claim 25, wherein at least one file element is arranged on the file base in such a manner that a minimum turning point of the machining surface one of lies in a plane defined by the sliding surface and is set back from the plane by a vertical distance in the depth direction.

34. The file according to claim 33, wherein the distance is less than 1.0 mm.

35. The file according to claim 25, wherein at least one file element is arranged to be mechanically preloaded in the depth direction on the file base body.

36. The file according to claim 25, wherein at least one file element is arranged to be mechanically preloaded in the depth direction, by fa compression spring, on the file base body.

37. The file according to claim 25, wherein at least one file element is arranged on the file base body so as to be adjustable in the depth direction.

38. The file according to claim 25, wherein at least one file element is arranged on the file base body so as to be adjustable in the depth direction by a translation thread.

39. The file according to claim 25, wherein at least one file element is arranged on the file base body so as to be adjustable in the depth direction by a translation fine thread.

40. The file according to claim 16, wherein at least one file element is designed in multiple pieces.

41. The file according to claim 16, wherein at least one file element comprises a file holding element and a file insert element held by the file holding element.

42. The file according to claim 16, wherein at least one file element forms a file base body to which the depth stop element is fastened.

43. The file according to claim 16, wherein at least one file element forms a file base body in which the depth stop element is inserted into a recess.

44. The file according to claim 16, wherein the non-abrasive sliding surface is designed to be convex at least in sections.

45. The file according to claim 16, wherein the non-abrasive sliding surface has an extremum.

46. The file according to claim 45, wherein the extremum (E) is a local extremum.

47. The file according to claim 45, wherein the extremum (E) is a maximum.

48. The file according to claim 45, wherein the extremum has a depth distance, which is orientated perpendicularly to a virtual connection line which is defined by contour end points of the abrasive machining surface that are facing one another.

49. The file according to claim 45, wherein the contour of the non-abrasive sliding surface has a width orientated perpendicularly to the longitudinal axis which is at most 0.3 mm.
